(19) United States
(12) Patent Application Publication
(10) Pub. No.: US 2008/0211383 A1
(43) Pub. Date: Sep. 4, 2008

(54) Flat display, method for manufacturing same and displacement prevention member for use in the flat display

(75) Inventors: Kiyoyuki Deguchi, Chiba (JP); Mitsuru Tanaka, Chiba (JP); Yasuyuki Naito, Chiba (JP)

Correspondence Address: BACON & THOMAS, PLLC, 625 SLATERS LANE, FOURTH FLOOR, ALEXANDRIA, VA, 22314, US

(73) Assignee: Futaba Corporation, Chiba (JP)

(21) Appl. No.: 12/007,196

(22) Filed: Jan. 8, 2008

(30) Foreign Application Priority Data
Jan. 9, 2007 (JP) 2007-001824

(51) Int. Cl. H01J 1/62; H01J 19/42; H01J 9/02

(52) U.S. Cl. 313/495; 313/292; 445/25

(57) ABSTRACT

A displacement prevention member of a flat display includes attachment surfaces respectively attached to inner surfaces of first and second substrates forming an airtight vessel of the flat display; and a bending part between the attachment surfaces. The bending part is bent in one direction on a plane perpendicular to the pressing direction of pressure applied in the perpendicular direction to inner surfaces of the substrates.

### FIELD OF THE INVENTION

The present invention relates to a flat display with an airtight vessel or a vacuum vessel such as a field emission display (FED) using field emission type electron emission sources, a surface conduction electron emitter display (SED) using surface conduction type electron emission sources, a fluorescent display tube, a plasma display and the like, a method for manufacturing the same and a displacement prevention member for use in the flat display.

### BACKGROUND OF THE INVENTION

A flat display includes an airtight vessel or a vacuum vessel formed of a glass anode substrate, a glass cathode substrate and a glass sealing member. When manufacturing the airtight vessel, the positions of the anode and cathode substrates are aligned with each other and the aligned positions have to be maintained during the sintering process after the position alignment. Therefore, a method for preventing the displacement between the anode substrate and the cathode substrate after the position alignment has been proposed (see, e.g., Japanese Patent Laid-open Application No. 2000-243277).

The conventional displacement prevention method will be described with reference to FIGS. 8A to 8D.

FIGS. 8A to 8D show an example of a field emission display (FED). FIG. 8A is a plan view thereof and FIG. 8B is a cross sectional view taken along the line X1-X1 in FIG. 8A. FIGS. 8C and 8D are drawings showing a method for manufacturing the display.

First, the example shown in FIGS. 8A and 8B will be described.

The FED includes an airtight vessel formed by installing a sealing member 12 between a cathode substrate 111 having an field emission type electron emission source C and an anode substrate 112 having an anode electrode A coated with a fluorescent material and attaching it to both the substrates 111 and 112. Support blocks 131 to 134 are attached to the cathode substrate 111, while thin plates 141 to 144 made of metal or the like are attached to the anode substrate 112. Further, the thin plates 141 to 144 are attached to the support blocks 131 to 134, respectively. The support blocks 131 to 134 and the thin plates 141 to 144 serve as the displacement prevention members for preventing the displacement between the cathode substrate 111 and the anode substrate 112 after the position alignment in manufacturing of the airtight vessel, as will be described later.

Next, the example shown in FIGS. 8C and 8D will be described.

In FIG. 8C, the support blocks 131 to 134 are attached to the cathode substrate 111, and the thin plates 141 to 144 are attached to the anode substrate 112. In FIG. 8D, after the sealing member 12 is attached to the cathode substrate 111, the anode substrate 112 is transferred to a position above the cathode substrate 111 and the sealing member 12, so that the positions of the substrates 111 and 112 are aligned with each other. While maintaining the position, the thin plates 141 to 144 are attached to the support blocks 131 to 134, respectively. After the attachment, if the anode substrate 112 is pressed along the X2 direction while being heated in a sintering oven, the thin plates 141 to 144 are bent downward and the anode substrate 112 is attached to the sealing member 12, which is in the state shown in FIG. 8B. Further, ceramic adhesive such as frit glass is used for the attachment.

Since the cathode substrate 111 and the anode substrate 112 are respectively attached to the support blocks 131 to 134 and the thin plates 141 to 144 during the sintering process, the substrates 111 and 112 are not displaced after the position arrangement.

However, in case of manufacturing the flat display by using the conventional displacement prevention member, a support block and a thin plate are used in pairs, which results in increase in the number of components. Further, in this method, the support blocks are attached to the cathode substrate, the thin plates are attached to the anode substrate and then the thin plates are attached to the support blocks, thereby increasing the number of the attached parts. Therefore, in accordance with the conventional displacement prevention method, the manufacturing process of the airtight vessel is complicated, and the utilization rate of the substrate is low due to the space needed for disposing the support blocks. Furthermore, the thin plates can be installed only in the vicinity of the anode substrate, which makes it difficult to completely prevent the displacement if a plurality of displays are manufactured by using a large single pane of glass at a time.

### SUMMARY OF THE INVENTION

In view of the above, the present invention provides a displacement prevention member having a simple structure, a simple attachment process and small attachment space, a flat display by using the displacement prevention member and a method for manufacturing the flat display.

In accordance with an embodiment of the present invention, there is provided a displacement prevention member of a flat display, the member including: attachment surfaces respectively attached to inner surfaces of first and second substrates forming an airtight vessel of the flat display; and a bending part between the attachment surfaces, the bending part being bent in one direction on a plane perpendicular to a pressing direction of pressure applied in the perpendicular direction to the inner surfaces of the substrates.

Preferably, at least two bending parts are arranged such that bending directions thereof are perpendicular to each other.

In accordance with another embodiment of the present invention, there is provided a flat display including: an airtight vessel including a first substrate, a second substrate and a sealing member; and the displacement prevention member described above and attached to each inner surface of the first and second substrates.

Preferably, at least two displacement prevention members are arranged such that bending directions thereof are perpendicular to one another.

In accordance with still another embodiment of the present invention, there is provided a flat display including: an airtight vessel including a first substrate, a second substrate and a sealing member; and the displacement prevention member described above and attached by adhesive to each inner surface of the first and second substrates.

In accordance with still another embodiment of the present invention, there is provided a method for manufacturing a flat display, the method including: attaching the displacement prevention member of claim 1 and a sealing member to an inner surface of a first substrate; attaching an inner surface of a second substrate to the displacement prevention member by transferring the second substrate to a position facing the first substrate and aligning the positions of the substrates; transferring the first and second substrates attached to each other into a sintering oven; and sealing them by applying pressure to the first substrate or to the second substrate while heating.

Preferably, at least two displacement prevention members are arranged such that bending directions thereof are perpendicular to one another.

In accordance with still another embodiment of the present invention, there is provided a method for manufacturing a flat display, the method including: attaching the displacement prevention member of claim 1 and a plurality of sealing members to an inner surface of a first large substrate; attaching an inner surface of a second large substrate to the displacement prevention member by transferring the second large substrate to a position facing the first large substrate and aligning the positions of the substrates; transferring the first and second large substrates attached to each other into a sintering oven; sealing them by applying pressure to the first large substrate or to the second large substrate while heating; and dividing into a plurality of flat displays after the sealing.

Preferably, at least two displacement prevention members are arranged such that bending directions thereof are perpendicular to one another.

The displacement prevention member of the present invention is formed of attachment surfaces each of which is attached or fixed to the first and the second substrate (anode and cathode substrates) and a bending part between the attachment surfaces, which results in a simple structure and a smaller size. Therefore, the displacement prevention member in accordance with the present invention can be manufactured at low cost and the attachment operation thereof is simply achieved by attaching (fixing) it to both of the substrates. Furthermore, installation space of the displacement prevention member can be smaller.

Since the displacement prevention member of the present invention is bent only in one direction by the applied pressure, the displacements of the substrates can be prevented simply by arranging two displacement prevention members such that bending directions thereof are perpendicular to each other. Accordingly, the number of the displacement prevention members is reduced, while the attachment operation is simpler and the attachment space is smaller. On the other hand, if the displacement in one direction is allowed on the basis of the structure of anode electrodes or the like forming pixels, it may also arrange only a single displacement prevention member. In such a case, the number and attachment space of the displacement prevention members may be further reduced.

The number and location of the displacement prevention members of the present invention can be freely determined depending on the size of the substrate or displacement prevention members. Therefore, the displacement can be completely prevented even for the case when the substrate is small as well as for the case when the substrate is large. Further, the displacement prevention members of the present invention can be used when a plurality of displays is formed by using a large substrate at a time. In such a case, the displacement prevention members can be installed either inside or outside the airtight vessel of each display. If the displacement prevention members are attached outside the airtight vessel, attachment space of the displacement prevention members need not be provided inside the airtight vessel. Therefore, the inside of the airtight vessel can effectively serve as a display area.

On the other hand, a single displacement prevention member of the present invention may have bending parts, i.e., bending surfaces, with different bending directions (non-bending directions), where the bending parts are arranged in such a manner that the bending directions (non-bending directions) thereof are perpendicular to each other. In such a case, the number and attachment space of the displacement prevention members are even further reduced.

### BRIEF DESCRIPTION OF THE DRAWINGS

The objects and features of the present invention will become apparent from the following description of embodiments given in conjunction with the accompanying drawings, in which:

FIGS. 1A to 1D show configurations of a field emission display (FED) in accordance with an embodiment of the present invention;

FIGS. 2A to 2C describe a manufacturing method of the FED shown in FIGS. 1A to 1D;

FIGS. 3A to 3D show examples of the arrangement of displacement prevention members;

FIGS. 4A to 4H show modified examples of the structure and shape of the displacement prevention members;

FIGS. 5A to 5C describe a method for manufacturing a plurality of FEDs at a time in accordance with the embodiment of the present invention;

FIGS. 6A to 6C show a modified example of the method for manufacturing the FEDs of FIGS. 5A to 5C;

FIG. 7 is an example of the arrangement of the displacement prevention members and getters in accordance with an embodiment of the present invention; and

FIGS. 8A to 8D illustrate a conventional displacement prevention method.

### DETAILED DESCRIPTION OF THE EMBODIMENTS

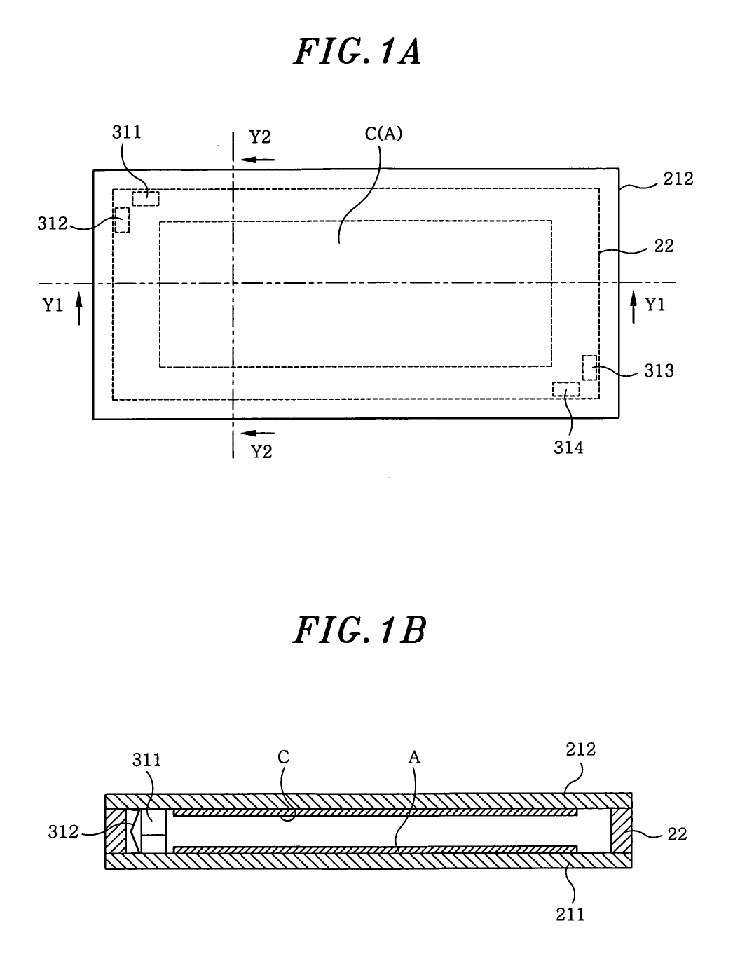

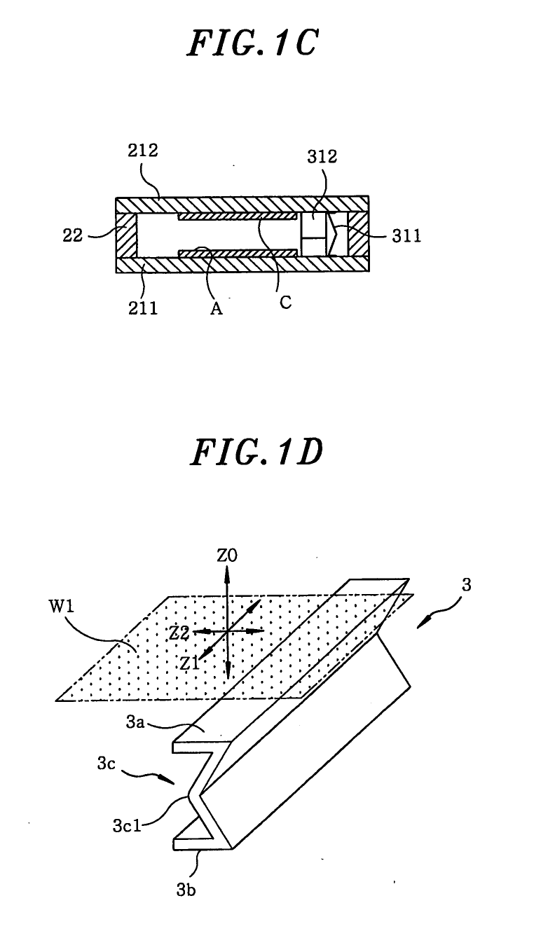

Hereinafter, embodiments of the present invention will be described in detail with reference to FIGS. 1A to 7 which form a part hereof. Further, identical reference numerals will be used for same parts in the drawings.

A field emission display (hereinafter, referred to as an “FED”), one of the flat displays in accordance with the embodiment of the present invention, will be described with reference to FIGS. 1A to 1D.

FIG. 1A is a plan view of the FED and FIG. 1B is a cross sectional view taken along the line Y1-Y1 in FIG. 1A. FIG. 1C is a cross sectional view taken along the line Y2-Y2 in FIG. 1A and FIG. 1D is a perspective view of a displacement prevention member.

The FED is configured such that a glass sealing member (side member) 22 is installed between a glass anode substrate 211 having an anode electrode A coated with a fluorescent material and a glass cathode substrate 212 having an field emission type electron source C and it is attached to both the substrates 211 and 212, thereby forming an airtight vessel (vacuum vessel). The gap between the anode substrate 211 and the cathode substrate 212 is predetermined by the height (thickness) of the sealing member 22. In general, a plurality of support columns for pressure resistance (spacers), which are made of fiber such as glass, metal or the like, is installed between the anode substrate 211 and the cathode substrate 212 but is not shown here.

Disposed between and attached to the anode substrate 211 and the cathode substrate 212 are displacement prevention members 311 to 314 to prevent the displacements of the substrates 211 and 212 in the FED manufacturing process. In the FED manufacturing process, the displacement prevention members 311 to 314, which have a same structure, are compressed by pressure applied in the perpendicular direction to inner surfaces of the substrates 211 and 212 while they are respectively attached to inner surfaces of the anode substrate 211 and cathode substrate 212 (surfaces where the anode electrode A and the field emission type electron source C are formed). At that time, the prevention members 311 to 314 are bent (or curved) and extruded (or protruded) only in one direction, which will be described in detail with reference to FIG. 1D. The displacement prevention members 311 to 314 are disposed outside the anode electrode A (or the display area) such that they do not contribute to display.

The displacement prevention members 311 to 314 are arranged in pairs, for example, two pairs 311 and 312, and 313 and 314. The two pairs of the displacement prevention members are installed at diagonally opposite corners of the anode and cathode substrates 211 and 212. The displacement prevention members in each pair, e.g., the displacement prevention members 311 and 312, are arranged so that the bending directions or non-bending directions of the prevention members 311 and 312 are perpendicular to each other. By arranging the displacement prevention members of each pair in this manner, there will be no displacements in the substrates 211 and 212 in the horizontal direction even though pressure is applied to the cathode substrate 212 in the sintering process. The two pairs of the displacement prevention members need not be diagonally arranged, but in doing so, the powers in the vertical and horizontal directions applied to the anode substrate 211 and the cathode substrate 212 are balanced, so that it is possible to surely prevent the displacement.

Further, although the displacement prevention member 311 is close to the displacement prevention member 312 in FIGS. 1A to 1C, it doesn't have to be arranged in this way. In FIG. 1A, the displacement prevention member 311 may be placed in the right and left direction from the position shown in FIG. 1A, similarly the displacement prevention member 312 may be placed in the up and down direction. This is also applied to the displacement prevention members 313 and 314.

Next, a structure and shape of the displacement prevention members 311 to 314 will be described with reference to FIG. 1D. Herein, one of the displacement prevention members 311 to 314 is indicated by a reference numeral 3.

The displacement prevention member 3 is made of materials having elasticity properties, i.e., spring properties, such as metal and is formed of attachment surfaces 3a and 3b and a bending part (curved portion) 3c, whose cross section is of an M shape. The attachment surfaces 3a and 3b of the displacement prevention member 3 are respectively attached to an inner surface of the anode substrate 211 where the anode electrode A is formed and an inner surface of the cathode substrate 212 where the electron source C is formed. The bending part 3c is provided with a curving part (folded line), 3c1 to make the bending easy. On the other hand, a groove may be formed instead of the curving part 3c1.

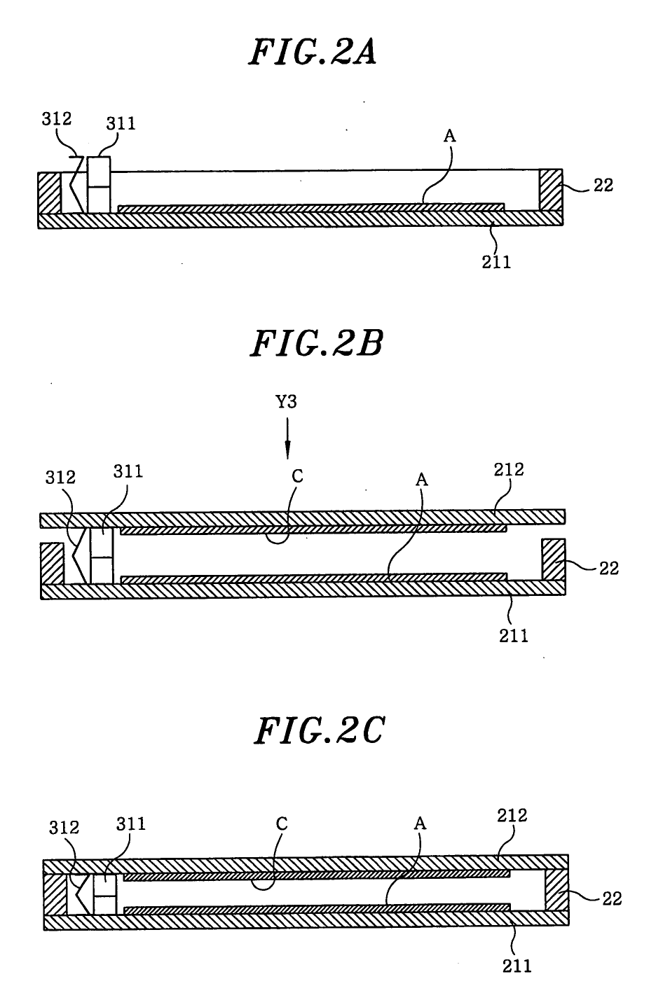

As will be described with reference to FIGS. 2A to 2C, the displacement prevention member 3 is compressed by the pressure applied in the perpendicular direction to inner surfaces of the substrates 211 and 212 while it being attached to the inner surfaces of the anode substrate 211 and cathode substrate 212. At that time, the displacement prevention member 3 is bent (curved) and extruded (protruded) only in one of the two perpendicular directions on a plane perpendicular to the pressing direction, i.e., to the loading direction, but it is not bent in the other direction. To be specific, in FIG. 1D, the bending part 3c is bent at the curving part 3c1 only in the Z2 direction of the two directions Z1 and Z2 on the plane W1 perpendicular to the pressing direction Z0, but it is not bent in the Z1 direction. In other words, the bending part 3c is bent only in one direction on the plane W1 perpendicular to the pressing direction Z0, whereas it is not bent in the other direction perpendicular to the direction. Further, the plane W1 perpendicular to the pressing direction Z0 is parallel to the attachment surfaces 3a and 3b. The Z1 direction in which the bending part 3c is not bent is parallel to the length direction of the bending part 3c, i.e., the length direction of the curving part 3c1.

Therefore, if the cathode substrate 212 is pressed down toward to the anode substrate 211 while the displacement prevention member 3 is attached to the inner surfaces of the anode substrate 211 and cathode substrate 212, both the substrates 211 and 212 are possibly displaced with respect to each other in the Z2 direction but they are not displaced in the Z1 direction.

Here, the displacement prevention member 3 is made of stainless steel with a thickness ranging from 0.1 mm to 0.15 mm.

Referring to FIGS. 1A to 1C, the displacement prevention members 311 and 312 are arranged in such a manner that the Z2 directions (or the Z1 directions) of the displacement prevention members 311 and 312 are perpendicular to each other. This applies to the displacement prevention members 313 and 314.

If the displacement prevention member 3 is made of metal, it may serve as a conductive member between the anode substrate 211 and the cathode substrate 212 as well as the displacement prevention member. Moreover, the anode substrate 211 and the cathode substrate 212 are provided with wiring for connecting the internal electrodes, e.g., the anode electrode A, the field emission type electron source C or the like, to outside the airtight vessel. In order to easily connect the wiring with an external circuit, the wiring can be concentrated on either the anode substrate 211 or the cathode substrate 212. In this case, the displacement prevention member 3 serves as a conductive member between the anode substrate 211 and the cathode substrate 212.

A manufacturing method of the FED shown in FIGS. 1A to 1D will be described with reference to FIGS. 2A to 2C.

As shown in FIG. 2A, the sealing member 22 is attached to the inner surface of the anode substrate 211 by using frit glass. Then, the displacement prevention members 311 and 312 are attached to the inner surface of the anode substrate 211 by heat resistant adhesive. Further, the displacement prevention members 313 and 314 shown in FIG. 1A are also attached thereto. After that, as shown in FIG. 2B, the cathode substrate 212 is transferred to a position facing the anode substrate 211, and the positions of the substrates 211 and 212 are aligned to each other. Subsequently, the inner surface of the cathode substrate 212 is attached to the displacement prevention members 311 and 312 by heat resistant adhesive. Further, the end face of the sealing member 22 is coated with frit glass (not shown). Here, an inorganic material is preferable as the heat resistant adhesive since it releases less gas while being heated.

After the attachment shown in FIG. 2B, the anode substrate 211 and the cathode substrate 212 in that state are transferred to a sintering oven. The cathode substrate 212 is then pressed in the Y3 direction perpendicular to the cathode substrate 212 while being heated. The cathode substrate 212 compresses the displacement prevention members 311 and 312 and at the same time the cathode substrate 212 moves down to pound (squash) the softened frit glass (not shown) of the end face of the sealing member 22 so that it is attached to the sealing member 22 as shown in FIG. 2C. After that, the FED is cooled and sealed. Since the bending directions of the displacement prevention members 311 and 312 are arranged perpendicularly to each other, the anode substrate 211 and the cathode substrate 212 are not relatively displaced in the horizontal direction while being pressed.

In the above-described embodiment, the displacement prevention members 311 and 312 are attached to the anode substrate 211 and the cathode substrate 212 by the heat resistance adhesive, respectively. Instead, a metal layer made of aluminum is formed on each substrate and each attachment surface of the displacement prevention members can be fixed to the metal layer by ultrasonic waves or laser beams. Further, in case of using the laser beams, each attachment surface of the displacement prevention members 311 and 312 can be directly fixed to the anode substrate 211 and the cathode substrate 212.

Although, in this embodiment, the sealing member 22 and the displacement prevention members 311 and 312 have been first attached to the anode substrate 211 and the cathode substrate 212 has been then attached to the displacement prevention members 311 and 312, the sealing member 22 and the displacement prevention members 311 and 312 can be first attached to the cathode substrate 212 and then the anode substrate 211 may be attached to the displacement prevention members 311 and 312. That is, the sealing member 22 and the displacement prevention members 311 and 312 can be first attached to either the anode substrate 211 or the cathode substrate 212, i.e., the first substrate, and the other substrate, i.e., the second substrate, may be then attached to the displacement prevention members 311 and 312.

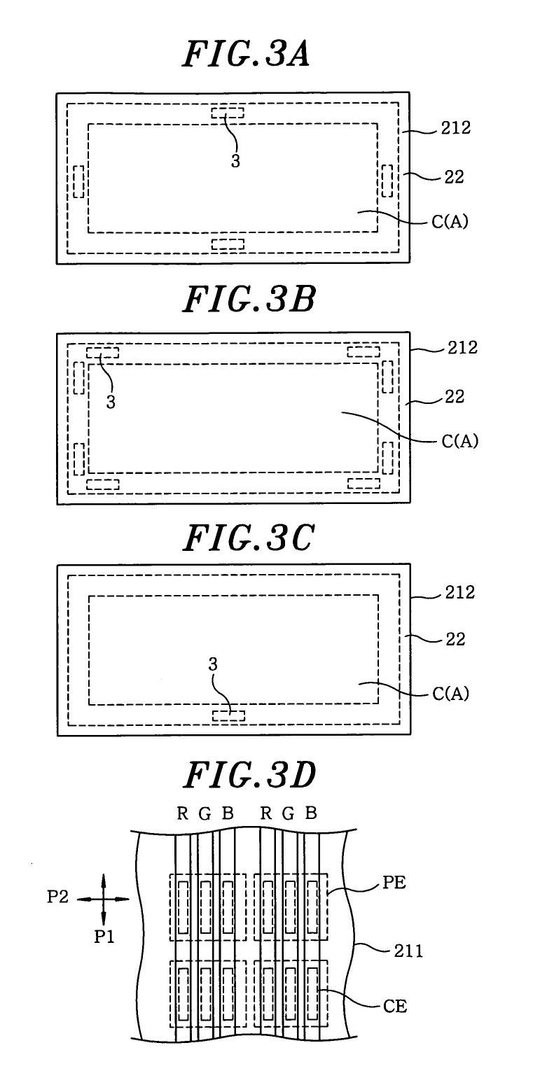

FIGS. 3A to 3D show examples of the arrangement of the displacement prevention members.

In FIG. 3A, four displacement prevention members 3 are arranged around the circumference of the cathode substrate 212 or the anode substrate 211. Among the four displacement prevention members 3, two displacement prevention members 3 facing to each other form a pair. The two displacement prevention members 3 in each pair have a same bending direction, while bending directions of the two pairs are perpendicular to each other. Referring to FIG. 3A, the two displacement prevention members 3 in each pair need not be aligned to face each other at exactly opposite positions and the locations thereof can be suitably selected depending on the availability of space along the cathode substrate 212 or the anode substrate 211. Further, only three displacement prevention members 3 may be arranged.

In FIG. 3B, eight displacement prevention members 3 in total are arranged around the four corners of the cathode substrate 212 or the anode substrate 211. That is, there are arranged four pairs of the displacement prevention members 3, where two displacement prevention members 3 in each pair have bending directions perpendicular to each other. Since a pair of the displacement prevention members 3 is arranged at each of the four corners in FIG. 3B, the displacement is surely prevented. Further, even when the cathode substrate 212 or the anode substrate 211 is large, it will prevent the displacement.

FIG. 3C shows an example where only a single displacement prevention member 3 is installed. In FIG. 3C, the cathode substrate 212 and the anode substrate 211 can be displaced in the bending direction of the displacement prevention member 3, which may be allowed in some cases. For example, as shown in FIG. 3D, if pixels PEs of the anode substrate 211 are formed of anode electrodes of a strap type having three colors RGB, any displacement of emitters CEs of the electron source of the anode and cathode substrates 211 and 212 in the P1 direction does not influence on the emission color. However, a displacement in the P2 direction results in that the neighboring color is emitted. Therefore, in case of FIG. 3D, only a single displacement prevention member 3 may work if its bending direction coincides with the P1 direction.

Further, the number or positions of the displacement prevention members are not limited to those shown in FIGS. 3A to 3C and may be properly determined based on the size of the anode or cathode substrate, the sizes (length, width and height) of the displacement prevention members and the like.

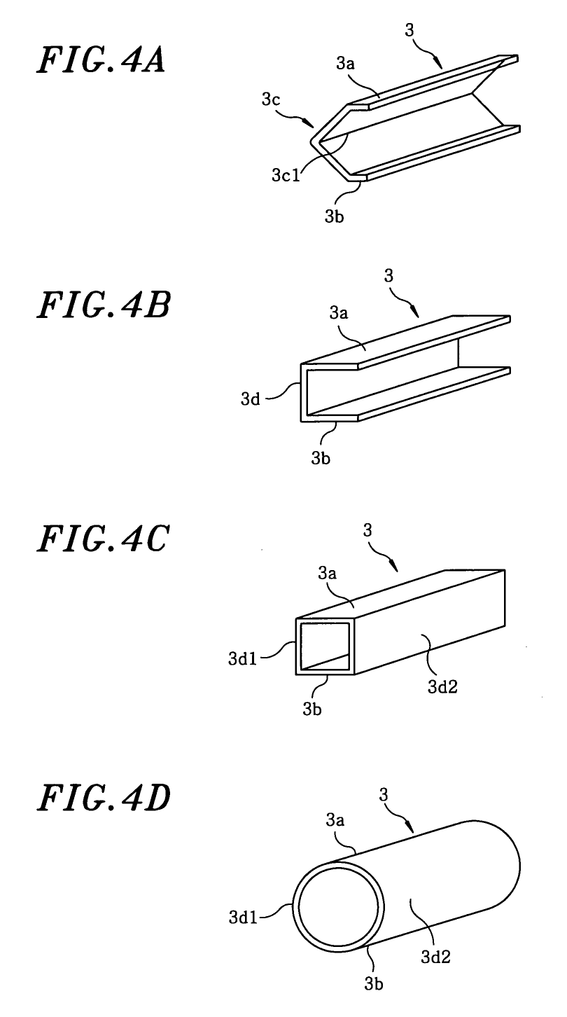

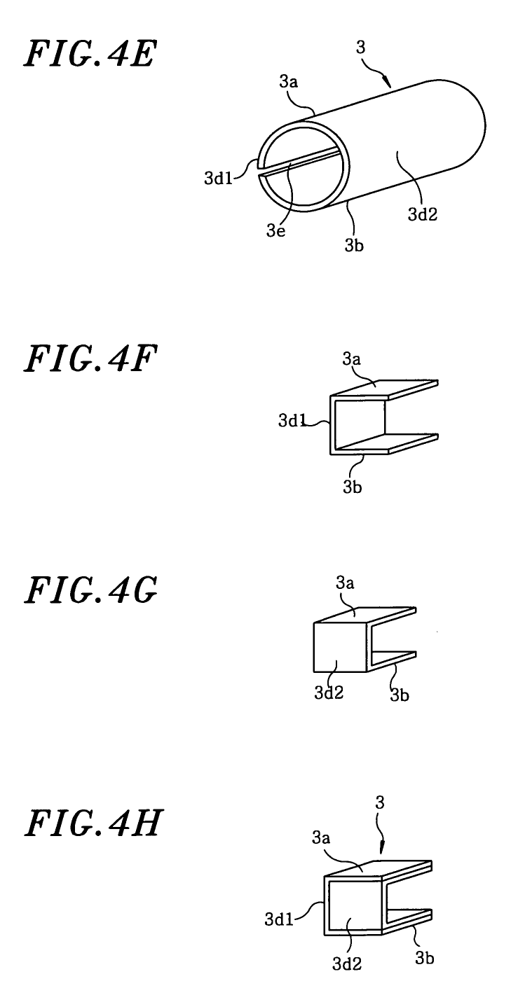

FIGS. 4A to 4H show modified examples of the structure and shape of the displacement prevention member.

A displacement prevention member 3 of FIG. 4A whose cross section is of a V shape is formed of attachment surfaces 3a and 3b and a bending part 3c between the surfaces 3a and 3b, the bending part 3c being provided with a curving part 3c1. Further, a groove may be formed instead of the curving part 3c1.

A displacement prevention member 3 of FIG. 4B in the form of a semi-rectangular pillar member whose cross section has a [symbol] shape is formed of attachment surfaces 3a and 3b and a bending part, i.e., a bending surface 3d between the surfaces 3a and 3b. The bending part 3d is bent (curved) inwardly or outwardly by the pressure applied to the attachment surfaces 3a and 3b. Further, a displacement prevention member 3 of FIG. 4C in the form of a pillar whose cross section has a [symbol] shape is formed of attachment surfaces 3a and 3b and bending parts (bending surfaces) 3d1 and 3d2 between the surfaces 3a and 3b.

A displacement prevention member 3 of FIG. 4D is in the form of a cylinder with a circular or elliptic cross section and includes attachment surfaces 3a and 3b (parts respectively attached to the anode and cathode substrates) and bending parts (bending surfaces) 3d1 and 3d2 between the attachment surfaces 3a and 3b. In a displacement prevention member 3 of FIG. 4E, a slit 3e in the axis (length) direction is formed through the bending part 3d1 of the displacement prevention member 3 shown in FIG. 4D. Because the displacement prevention member 3 of FIG. 4E is provided with the slit 3e, it is easily compressed. Furthermore, the slit 3e may also be a groove.

A displacement prevention member 3 of FIG. 4H is formed by inserting the [symbol] -shaped displacement prevention member shown in FIG. 4G into the [symbol] -shaped displacement prevention member shown in FIG. 4F in such a manner that a bending part (bending surface) 3d1 of the displacement prevention member shown in FIG. 4F and a bending part (bending surface) 3d2 of the displacement prevention member shown in FIG. 4G are perpendicular to each other. In such a case, contact parts of the bending parts 3d1 and 3d2 are not attached or fixed to each other.

Since a displacement prevention member 3 shown in FIG. 4H serves to perform functions of two displacement prevention members, the operation of attaching it to the anode or cathode substrate is efficiently performed and installation space is small. Further, the displacement prevention member 3 shown in FIG. 4H may be configured to have four bending parts or bending surfaces. In this case, there are two pairs of the bending parts (bending surfaces), facing each other, whereby one displacement prevention member serves to perform functions of four displacement prevention members.

Referring to FIGS. 4B to 4D and 4F to 4H, the bending part or the bending surface of each displacement prevention member 3 may be provided with a groove in the length direction, which makes bending easy, so that the bending part can be easily bent only in one direction on the plane perpendicular to the pressing direction, i.e., the loading direction as described with reference to FIG. 1D.

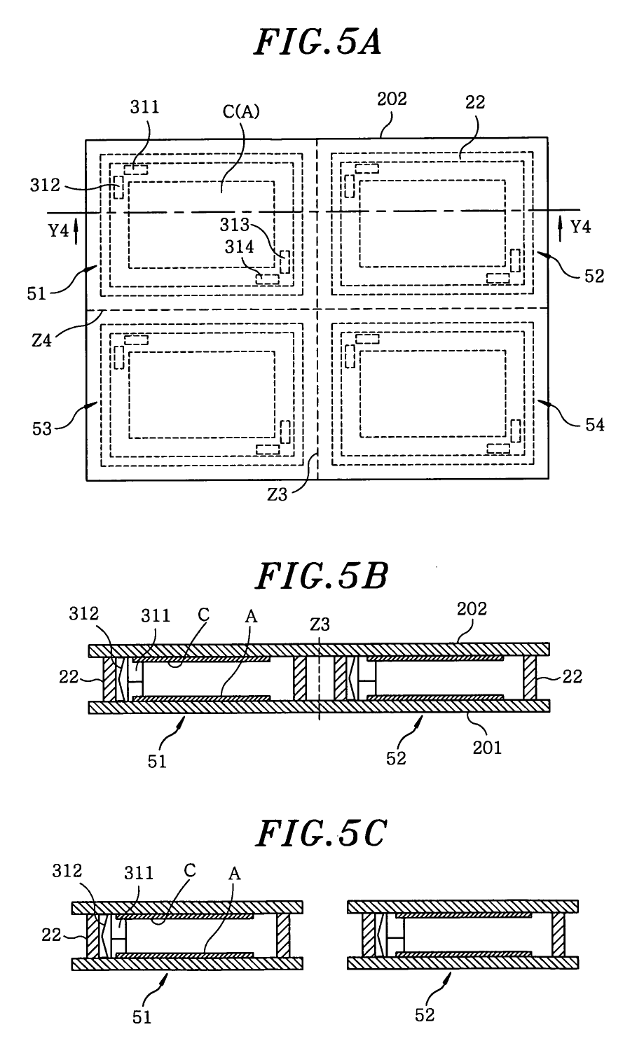

Next, a method for manufacturing four FEDs shown in FIGS. 1A to 1D at a time will be described with reference to FIGS. 5A to 5C.

FIG. 5A is a plan view of the four FEDs formed on a large single pane of glass, a large substrate, and FIG. 5B is a cross sectional view taken along the line Y4-Y4 in FIG. 5A. Further, FIG. 5C shows a cross sectional view of each of the FEDs.

The FEDs shown in FIGS. 5A and 5B are fabricated in the same sequence as those of FIGS. 2A to 2C. Sealing members 22 of the four FEDs 51 to 54 are attached to an inner surface of a large substrate 201 by using frit glass and displacement prevention members 311 to 314 are respectively attached to inner areas of sealing members 22 by heat resistant adhesive. Further, a large substrate 202 is transferred to a position facing the large substrate 201 and the positions of the substrates 201 and 202 are aligned to each other. Then, an inner surface of the large substrate 202 is attached to the displacement prevention members 311 and 314 by heat resistant adhesive. Further, the end face of each sealing member 22 is coated with frit glass. In a sintering oven, the large substrate 202 is pressed down to the large substrate 201 while being heated, whereby the large substrate 202 is attached to the sealing member 22 to be sealed. Accordingly, the displacement prevention members 311 to 314 prevent the displacements of the large substrates 201 and 202 in the horizontal direction.

As shown in FIG. 5C, after the large substrates 201 and 202 and the sealing member 22 are attached and sealed, the two FEDs 51 and 52 are separated by cutting along Z3 and Z4 lines shown in FIG. 5A and so are the FEDs 53 and 54.

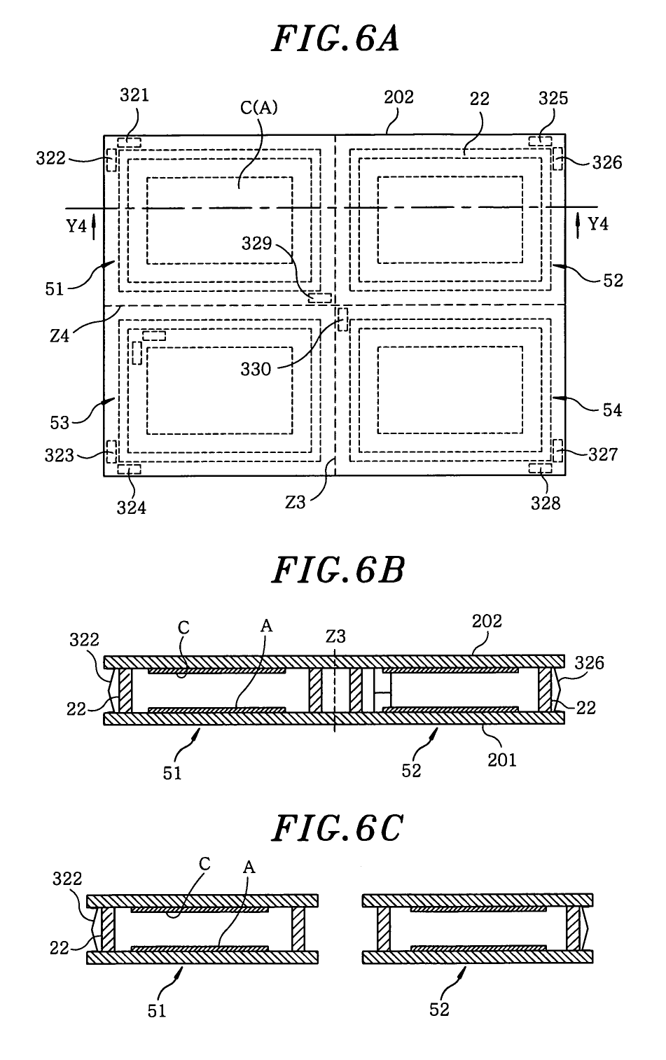

FIGS. 6A to 6C show a modified example of the method for manufacturing the FEDs of FIGS. 5A to 5C.

FIG. 6A is a plan view of four FEDs formed on a large substrate and FIG. 6B is a cross sectional view taken along the line Y4-Y4 in FIG. 6A. Further, FIG. 6C shows cross sectional views of the FEDs.

The FED manufacturing method shown in FIGS. 6A to 6C is basically the same as that shown in FIGS. 5A to 5C except that displacement prevention members 321 to 330 are disposed outside sealing members 22.

Since the displacement prevention members 321 to 330 are disposed outside the sealing members 22 in accordance with the FED manufacturing method of FIGS. 6A to 6C, space for arranging the displacement prevention members 321 to 330 need not be provided inside the FEDs 51 to 54. Further, the displacement prevention members 321 to 330 may be located only at the four corners and the center of the large substrates 201 and 202, which reduces the number of the displacement prevention members and further makes the attachment operation simple.

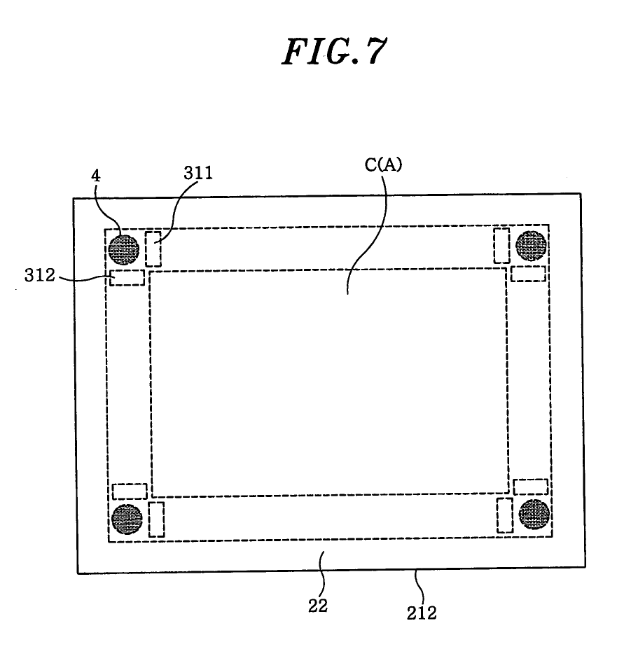

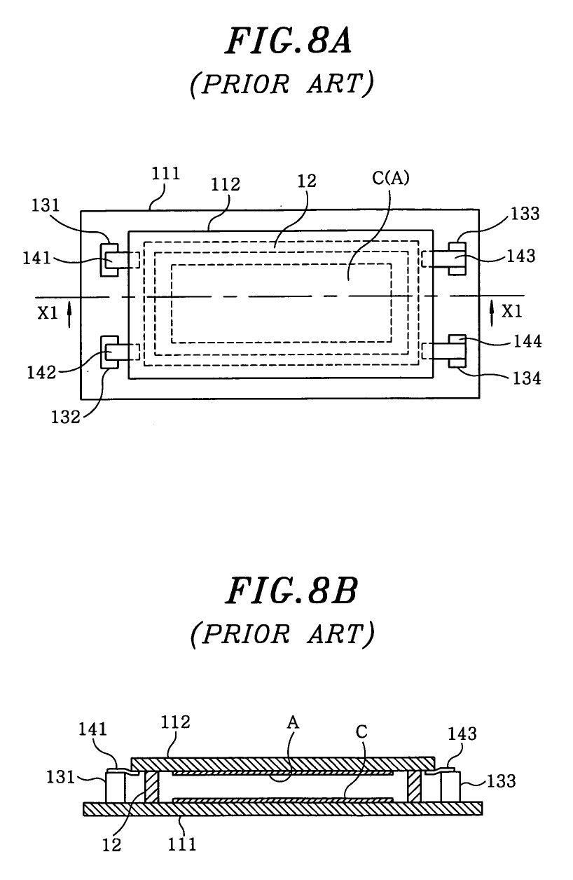

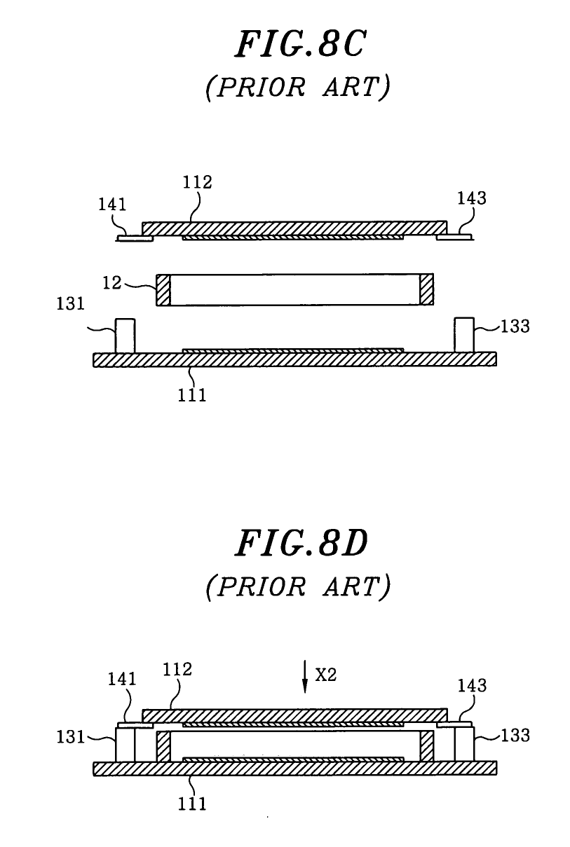

FIG. 7 shows an example of the arrangement of displacement prevention members and getters.

In FIG. 7, installed at the four corners inside an FED are getters 4 and displacement prevention members 311 and 312 to surround each getter 4. If the getters 4 are evaporated, they are scattered everywhere to form a getter mirror on the cathode substrate 212 or on the anode substrate 211. However, in case of FIG. 7, evaporated getter materials can be prevented from being scattered to an electron source C and an anode electrode A. Therefore, in FIG. 7, the displacement prevention members 311 and 312 also function as members for preventing the getter materials from being scattered.

Although the above embodiment has been described with respect to the FED, it is not limited thereto, and it can also be applied to various flat displays such as a surface conduction electron emitter display (SED), a fluorescent display tube, a plasma display or the like.

While the invention has been shown and described with respect to the embodiments, it will be understood by those skilled in the art that various changes and modifications may be made without departing from the scope of the invention as defined in the following claims.

What is claimed is:

1. A displacement prevention member of a flat display, the member comprising:
attachment surfaces respectively attached to inner surfaces of first and second substrates forming an airtight vessel of the flat display; and
a bending part between the attachment surfaces, the bending part being bent in one direction on a plane perpendicular to a pressing direction of pressure applied in the perpendicular direction to the inner surfaces of the substrates.

2. The displacement prevention member of claim 1, wherein at least two bending parts are arranged such that bending directions thereof are perpendicular to each other.

3. A flat display comprising:
an airtight vessel including a first substrate, a second substrate and a sealing member; and
the displacement prevention member of claim 1 attached to each inner surface of the first and second substrates.

4. The flat display of claim 3, wherein at least two displacement prevention members are arranged such that bending directions thereof are perpendicular to one another.

5. A flat display comprising:
an airtight vessel including a first substrate, a second substrate and a sealing member; and
the displacement prevention member of claim 2 attached by adhesive to each inner surface of the first and second substrates.

6. A method for manufacturing a flat display, the method comprising:
attaching the displacement prevention member of claim 1 and a sealing member to an inner surface of a first substrate;
attaching an inner surface of a second substrate to the displacement prevention member by transferring the second substrate to a position facing the first substrate and aligning the positions of the substrates;
transferring the first and second substrates attached to each other into a sintering oven; and
sealing them by applying pressure to the first substrate or to the second substrate while heating.

7. The method of claim 6, wherein at least two displacement prevention members are arranged such that bending directions thereof are perpendicular to one another.

8. A method for manufacturing a flat display, the method comprising:
attaching the displacement prevention member of claim 1 and a plurality of sealing members to an inner surface of a first large substrate;
attaching an inner surface of a second large substrate to the displacement prevention member by transferring the second large substrate to a position facing the first large substrate and aligning the positions of the substrates;
transferring the first and second large substrates attached to each other into a sintering oven;
sealing them by applying pressure to the first large substrate or to the second large substrate while heating; and
dividing into a plurality of flat displays after the sealing.

9. The method of claim 8, wherein at least two displacement prevention members are arranged such that bending directions thereof are perpendicular to one another.
